(19) United States
(12) Patent Application Publication
(10) Pub. No.: US 2002/0027845 A1
(43) Pub. Date: Mar. 7, 2002

(54) Reproduction apparatus, reproduction method, program, and recording medium

(76) Inventors: Tomoko Sogabe, Kyoto (JP); Takeshi Fujita, Osaka (JP); Masahiro Sueyoshi, Osaka (JP)

Correspondence Address: Neil A. DuChez, Renner, Otto, Boisselle, & Sklar, L.L.P., 19th Floor, 1621 Euclid Avenue, Cleveland, OH, 44115, US

(21) Appl. No.: 09/943,470

(22) Filed: Aug. 30, 2001

(30) Foreign Application Priority Data
Sep. 5, 2000 (JP) 2000-268250

(51) Int. Cl. G11B 7/005

(52) U.S. Cl. 369/47.22

(57) ABSTRACT

A reproduction apparatus includes a signal input section for receiving an input signal, an Input signal determination section for determining a type of the input signal based on whether or not a first synchronization signal among a series of N synchronization signal exists within a predetermined search area of the input signal (N is an integer equal to or greater than 2); and a signal processing section for performing a signal processing process selected according to the type of the input signal on the Input signal.

### BACKGROUND OF THE INVENTION

1. Field of the invention

The present invention relates to a reproduction apparatus, a reproduction method, a program, and a recording medium capable of reproducing a digital sound signal and an encoded stream signal which are recorded on a recording medium.

2. Description of the related art

Conventionally, a digital sound signal is recorded on a recording medium, such as a compact disk (CD), a digital audio tape (DAT), eta., according to a recording method called “2ch-16bit-PCM (pulse code modulation)”. In this specification, a digital sound signal which is recorded according to this recording method is referred to as a “PCM digital sound signal”.

In recent years, a technique for recording on a recording medium, such as a CD, a DAT, etc., a digital sound signal which is encoded according to a predetermined encoding method has been developed. For example, a known example of the predetermined encoding method is an MPeg audio layer 3 (MP3) method. In this specification, a digital sound signal which is encoded according to the MP3 method is referred to as a “MP3 stream signal”.

The MP3 method is one of the specifications of MPEG (Motion picture Expert Group). According to the MP3 method, a digital sound signal is encoded at a variable rate, and the encoded digital sound signal Is recorded on a CD.

In the case of a PCM digital sound signal recorded in a CD, the PCM digital sound signal is converted from a digital to an analog signal, whereby the PCM digital sound signal recorded in the CD is reproduced. On the other hand, in the case of an encoded digital sound signal recorded in a CD, the encoded digital sound signal cannot be reproduced without performing D/A-conversion after the encoded digital sound signal is decoded.

In a conventional reproduction technique, whether a digital sound signal (input signal) is a PCM digital sound signal or a digital sound signal encoded at a fixed rate is determined by checking the frequency of appearance of a synchronization signal which is detected in the digital sound signal encoded at the fixed rate, and the input signal is subjected to a signal processing process selected according to the type of the input signal. Such a technique is disclosed in, for example, Japanese Laid-Open Publication No. 11-355179 (Title of the Invention: REPRODUCTION APPARATUS AND REPRODUCTION METHOD).

However, according to the above conventional technique, in the case where an input signal is a digital sound signal encoded at a variable rate, the type of the input signal cannot be correctly determined. This is because a synchronization signal in the digital sound signal encoded at a variable rate does not appear in a periodical manner. The digital sound signal encoded at a variable rate is not decoded before it is converted from a digital to an analog signal, and as a result, noise may be output, from a reproduction apparatus.

### SUMMARY OF THE INVENTION

According to one aspect of the present invention, a reproduction apparatus includes: a signal input section for receiving an input signal; an input signal determination section for determining a type of the input signal based on whether or not a first synchronization signal among a series of N synchronization signal exists within a predetermined search area of the input signal (N is an integer equal to or greater than 2); and a signal processing section for performing a signal processing process selected according to the type of the input signal on the input signal.

In one embodiment of the present invention, the Input signal includes a variable-length frame including a header portion and a data portion: and the input signal determination section determines whether or not a synchronization signal exists within the predetermined search area and, when a synchronization signal exists within the predetermined search area, calculates a position of a next synchronization signal based on the length of the frame so as to determine whether a next synchronization signal exists at the calculated position of the next synchronization signal.

In another embodiment of the present invention, the length of the frame is calculated based on a bit rate of the header portion and a sampling frequency of the header portion.

In still another embodiment of the present invention, the input signal determination section modifies the predetermined search area if a next synchronization signal does not exist at the calculated position of the next synchronization signal so as to determine whether or not a synchronization signal exists within the modified predetermined search area.

In still another embodiment of the present invention, the input signal includes a variable-length frame including a header portion and a data portion; and the input signal determination section determines whether or not a bit rate of the header portion has a value which indicates that the bit rate is indefinite and, when the bit rate of the header portion has a value which indicates that the bit rate is indefinite, modifies the predetermined search area so as to determine whether a synchronization signal exists within the modified predetermined search area.

In still another embodiment of the present invention, the input signal includes a variable-length frame including a header portion and a data portion; and the input signal determination section modifies the predetermined search area based on a value of a bit rate of the header section and at least one of data which indicates a state of the frame of the header portion except for the value of the bit rate of the header section so as to determine whether or not a synchronization signal exists within the modified predetermined search area.

In still another embodiment of the present invention, the predetermined search area is 2 Kbyte.

In still another embodiment of the present invention, when the first synchronization signal among the series of N synchronization signal exists within the predetermined search area, the input signal determination section determines that the input signal is an encoded digital sound signal

In still another embodiment of the present invention, when the first synchronization signal among the series of N synchronization signal does not exist within the predetermined search area, the input signal determination section determines that the input signal is a pulse code modulation (PCM) digital sound signal.

In still another embodiment of the present invention, the input signal determination section includes: a data counter for counting a data amount of the input, signal to output an address of the input signal; a synchronization signal detection section for detecting a synchronization signal in the input signal to output a detection signal which indicates a result of the detection; a synchronization signal counter storage section in which the detection signal is incremented based on the detection signal output from the synchronization signal detection section; a first synchronization signal address storage section for storing the address output from the data counter in response to a detection signal resulting, from a first synchronization signal; and a type determination section for determining the type of the input signal based on whether or not the address stored in the first synchronization signal address storage section exists within the predetermined search area and based on whether or not the value of the synchronization signal counter storage section is equal to or greater than N.

In still another embodiment of the present invention, the Input signal includes a variable-length frame including synchronization signal, a header portion, and a data portion; and the input signal determination section further includes a header information analyzing section for calculating a length of the variable-length frame including the detected synchronization signal in response to the detection signal so as to calculate an address Interval between the detected synchronization signal and a next synchronization signal, and a next synchronization signal address storage section which calculates an address of a next synchronization signal next to the first synchronization signal based on the address stored in the first synchronization signal address storage section and the calculated address interval and, when the calculated address of the next synchronization signal matches the address output from the data counter, stores the address output from the data counter.

In still another embodiment of the present invention, the reproduction apparatus further Includes a host controller for changing an operating condition of the input signal determination section.

In still another embodiment of the present invention, the operating condition of the input signal determination section includes at least one of a minimum unit of the input signal, the predetermined search area, and the value N.

In still another embodiment of the present invention, the minimum unit of the input signal is 1 bit.

In still another embodiment of the present invention, the input signal includes a variable-length frame including a header portion and a data portion; and the predetermined search area is greater than the length of the frame.

In still another embodiment of the present invention, the reproduction apparatus further includes a host controller for changing an operating condition of the input signal determination section, wherein the operating condition of the input signal determination section includes the modified predetermined search area.

In still another embodiment of the present invention, a leading address of the modified search area is at a position at least one bit greater than a last address of the first synchronization signal among the series of N synchronization signals.

In still another embodiment of the present invention, the reproduction apparatus further includes a host controller for changing an operating condition of the input signal determination section, wherein the operating condition of the input signal determination section is a value of at least one of data which Indicates a state of the frame included in the header portion.

In still another embodiment of the present invention, the host controller prioritizes the value of the at least one of the data which indicates the state of the frame included in the header portion and changes the value of the at least one of the data which indicates the state of the frame included in the header portion based on the priority of the value.

According to another aspect of the present invention, a reproduction method includes steps of: receiving an input signal; determining a type of the input signal based on whether or not a first synchronization signal among a series of N synchronization signal exists within a predetermined search area of the input signal (N is an Integer equal to or greater than 2); and performing a signal processing selected according to the type of the input signal on the input signal.

According to still another aspect of the present invention, there is provided a program for directing a computer to perform a reproduction process, the reproduction process comprising steps of: receiving an input signal; determining a type of the input signal based on whether or not a first synchronization signal among a series of N synchronization signal exists within a predetermined search area of the input signal (N is an integer equal to or greater than 2); and performing a signal processing selected according to the type of the input signal on the input signal.

According to still another aspect of the present invention, there is provided a computer-readable recording medium containing a program for directing a computer to perform a reproduction process, the reproduction process comprising steps of: receiving an input signal; determining a type of the input signal based on whether or not a first synchronization signal among a series of N synchronization signal exists within a predetermined search area of the input signal (N is an integer equal to or greater than 2); and performing a signal processing process selected according to the type of the input signal on the input signal.

Thus, the Invention described herein makes possible the advantages of providing a reproduction apparatus, a reproduction method, a program, and a recording medium capable of determining whether an input signal is a PCM signal or a digital sound signal encoded at a variable rate.

These and other advantages of the present invention will become apparent to those skilled I n the art upon reading and understanding the following detailed description with reference to the accompanying figures.

### BRIEF DESCRIPTION OF THE DRAWINGS

FIG. 1 shows a structure of a reproduction apparatus 1 according to embodiment 1 of the present invention.

FIG. 2A shows a format of a MP3 stream signal 100.

FIG. 2B shows a format of a PCM signal 200.

FIG. 3 shows a structure of the input signal determination section 20.

FIG. 4 is a flowchart for illustrating an operation of the input signal determination section 20 shown in FIG. 3.

FIG. 5A shows an example of an input signal where the value of a synchronization signal counter storage section 23 is equal to or greater than a predetermined threshold value N (N=255).

FIG. 5B shows a predetermined (unmodified) search area and a modified search area.

FIG. 6A shows an input signal where data contained before a signal 72 is only a series of “F”s.

FIG. 6B shows a specific example of a PCM digital sound signal which includes signals identical to a synchronization signal included in a MP3 stream signal.

FIG. 6C shown a specific example of a MP3 stream signal with an irregular frame arrangement where a frame is connected to an intermediate portion of a previous frame.

FIG. 7 is a flowchart of an analyzing process of a frame header performed by the input signal determination section 20.

FIG. 8 shows a structure of a reproduction apparatus 2 according to embodiment 2 of the present invention.

### DESCRIPTION OF THE PREFERRED EMBODIMENTS

Hereinafter, embodiments of the present invention will be described with reference to the drawings.

Embodiment 1

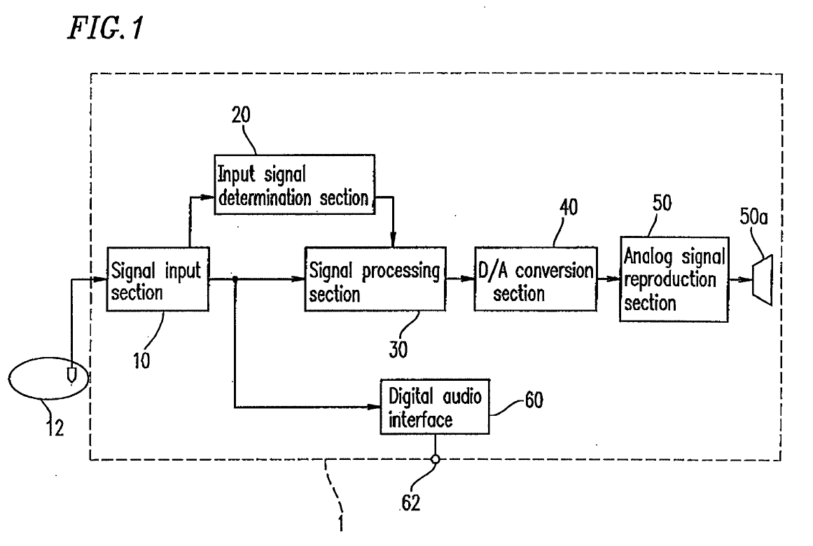

FIG. 1 shows a structure of a reproduction apparatus 1 according to embodiment 1 of the present invention. A signal read from a recording medium 12 is input into the reproduction apparatus 1. In a typical example, the recording medium 12 is a CD. However, the recording medium 12 may be a DAT.

In this example, the signal input from the recording medium 12 to the reproduction apparatus 1 is a MP3 stream signal 100 or a PCM signal 200. However, the signal input to the reproduction apparatus 1 is not limited to these signals. The present invention can be applied to any type of signal as long as the type of an input signal which is input to the reproduction apparatus 1 can be determined based on whether a first synchronization signal among a series of synchronization signals exists within a predetermined search area of the input signal.

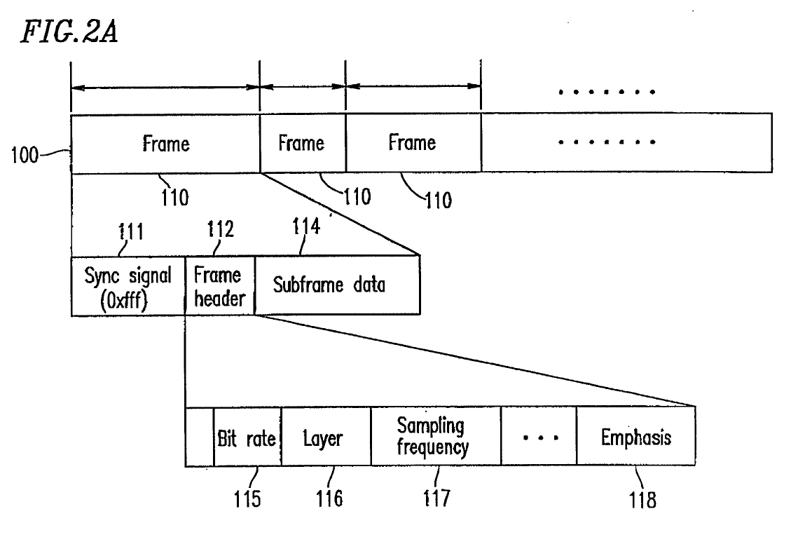

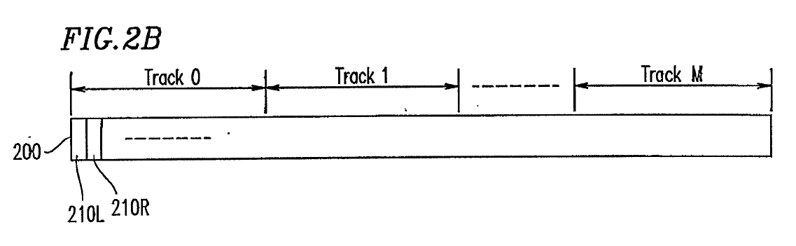

FIG. 2A shows a format of a MP3 stream signal 100.

The MP3 stream signal 100 includes a plurality of frames 110. Each of the frames 110 includes a synchronization signal 111, a frame header 112, and a subframe data 114.

In the MP3 stream signal 100, the synchronization signal 111 is 12-bit data. The synchronization signal 111 has a value “0×fff”. The frame header 112 is 20-bit data The frame header 112 includes “frame state data” which represents the state of a frame 110 including that frame header 112. The frame state data includes a bit rate 115, a layer 116, a sampling frequency 117, an emphasis 118, etc. In the MP3 stream signal 100, the bit rate 115 has values from “0×00” to “0×0f”. In embodiment 1 , if the bit rate 115 has a value “0×00” or “0×0f”, the bit rate is indeterminate.

FIG. 2B shows a format of a PCM signal 200.

The PCM signal 200 is recorded in a plurality of tracks in the recording medium 12 (for example, track 0, track 1, . . . track M, where M is any integer).

The PCM signal 200 alternately includes signals 210L for a left channel and signals 210R for a right channel.

Referring to FIG. 1 again, the reproduction apparatus 1 includes a signal input section 10 for receiving an input signal from the recording medium 12; an input signal determination section 20 for determining the type of the input signal based on whether a first synchronization signal among a series of N synchronization signals exists within a predetermined search area of the input signal (N is an integer equal to or greater than 2), and a signal processing section 30 for performing a signal processing process selected according to the determined type of the input signal on the input signal.

The input signal determination section 20 determines whether or not a synchronization signal exists within a predetermined search area of the input signal. If a synchronization-signal exists within the predetermined search area of the input signal, the input signal determination section 20 calculates the position of a next synchronization signal based on the length of a frame. Then, the input signal determination section 20 determines whether or not a synchronization, signal exists at the calculated position. Calculation of the length of a frame will be described later in detail.

If a synchronization signal does not exist at the calculated next position of a synchronization signal, the input signal determination section 20 modifies the predetermined search area. Then, the input signal determination section 20 determines whether or not a synchronization signal exists within the modified search area of the input signal,

The input signal determination section 20 determines whether or not a bit rate included in a header portion of the input signal has a value which indicates that the bit rate is indeterminate. If the bit rate has a value which indicates that the bit rate is indeterminate, the input signal determination section 20 modifies the search area and determines whether or not a synchronization signal exists within the modified search area of the input signal.

The input signal determination section 20 determines whether a first synchronization signal of a series of N synchronization signals exists within the predetermined search area. If the first synchronization signal of the series of N synchronization signals exists within the predetermined search area, the input signal determination section 20 determines that the input signal is a MP3 stream signal 100.

If the first synchronization signal of the series of N synchronization signals does not exist within the predetermined search area, the input signal determination section 20 determines that the input signal is a PCM signal 200.

Then, the input signal determination section 20 outputs a detection signal which indicates the type of the input signal to the signal processing section 30. For example, in the case where the input signal is a MP3 stream signal 100, the input signal determination section 20 outputs a detection signal having a value “1” to the signal processing section 30. In the case where the input signal is a PCM signal 200, the input signal determination section 20 outputs a detection signal having a value “0” to the signal processing section 30.

The reproduction apparatus 1 may inform a user thereof the result of detection by the input signal determination section 20. There are various methods for informing a user of the reproduction apparatus 1 about a detection result. For example, in the case where the input signal is a MP3 stream signal 100, a “MP3 indicator” may be displayed on a liquid crystal panel (not shown) of the reproduction apparatus 1. In the case where the input signal is a PCM signal 200, a “PCM indicator” may be displayed on the liquid crystal panel of the reproduction apparatus 1. Alternatively, in the case where a MP3 stream signal 100 is input to the reproduction apparatus 1, the reproduction apparatus 1 may output a sound message, “This reproduction apparatus cannot reproduce a MP3 stream signal Please connect an external receiver to an external terminal for a digital audio Interface”.

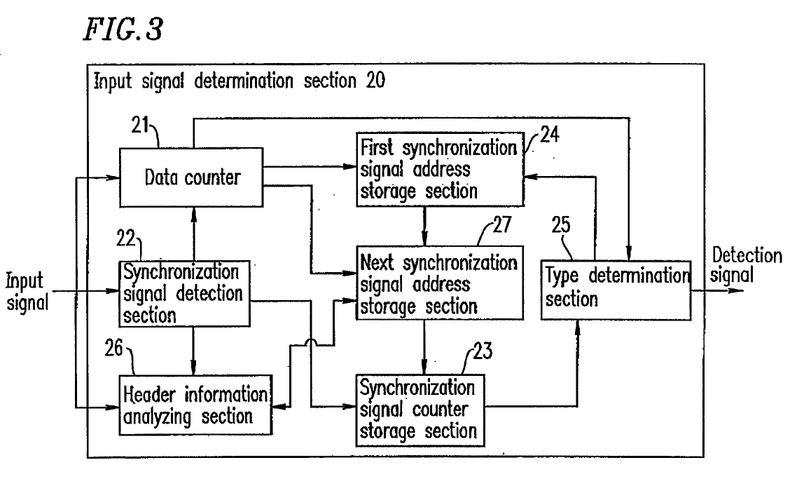

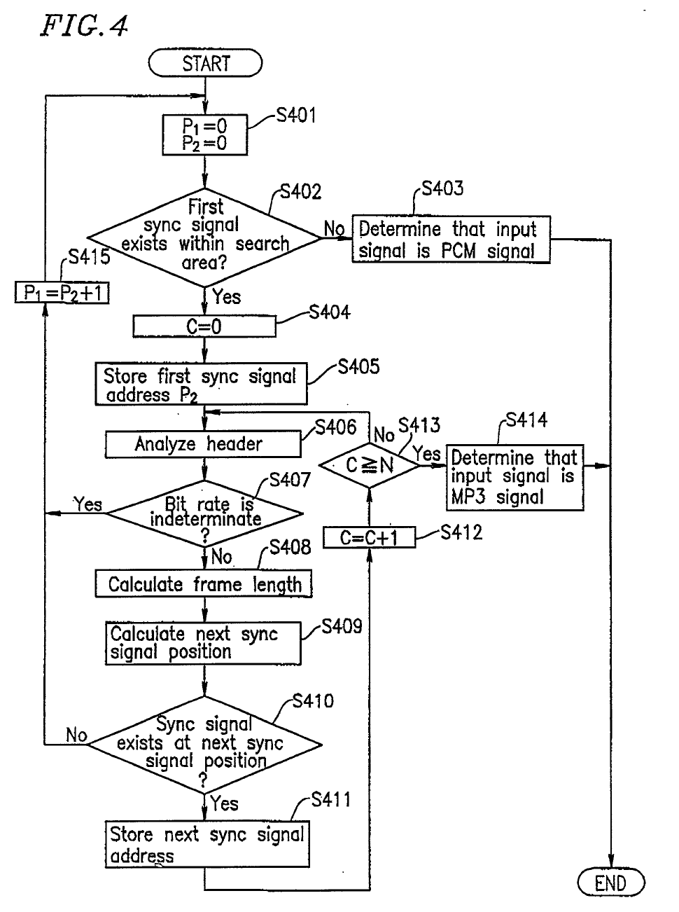

A structure of the input signal determination section 20 will be described later in detail with reference to FIG. 3. An operation of the input signal determination section 20 will be described later in detail with reference to FIG. 4.

When the signal processing section 30 receives a detection signal indicating that the input signal is a PCM signal 200, the signal processing section 30 outputs the input signal received from the signal input section 10 to a D/A conversion section 40. When the signal processing section 30 receives a detection signal indicating that the input signal is a MP3 stream signal 100, the signal processing section 30 prohibits the input signal received from the signal input section 10 from being output to the D/A conversion section 40. For example, in the case where the input signal is a MP3 stream signal 100, the signal processing section 30 may reduce the signal level of the input signal to 0, or may change a route of the input signal such that the input signal is not output to the D/A conversion section 40.

Alternatively, in the case where the input signal is a MP3 stream signal 1001 the signal processing section 30 may suppress the signal level of the input signal and output the input signal with a suppressed signal level to the D/A conversion section 40.

With such an operation of the signal processing section 30, a MP3 stream signal 100 is prevented (or restrained) from being output to the D/A conversion section 40 before it is decoded. As a result, emission of noise by the reproduction apparatus 1 is prevented (or noise emitted by the reproduction apparatus 1 is reduced).

The reproduction apparatus 1 may be structured such that a default of the signal level of a signal output from the signal processing section 30 is set to 0 (or a suppressed value), and the signal level of the signal output from the signal processing section 30 is amplified only when the input signal determination section 20 determines that the input signal is a PCM signal 200. With such a control, emission of noise by the reproduction apparatus 1 can be prevented (or noise emitted by the reproduction apparatus 1 can be reduced).

A digital signal output from the signal processing section 30 is converted to an analog signal by the D/A conversion section 40. The analog signal output from the D/A conversion section 40 passes through an analog signal reproduction section 50 and then Is emitted by an output device 50a (e.g., a speaker).

The input signal output from the signal input section 10 is also supplied to a digital audio interface 60 The digital audio interface 60 converts the input signal into a digital signal having a predetermined format (e.g, IEC 958 format), and outputs the digital signal through an external terminal 62 to outside of the reproduction apparatus 1. As the digital audio interface 60, for example, a SPDIF (Sony Philips Digital InterFace) may be employed. To the external terminal 62, for example, an external receiver (not shown) including a decoder capable of decoding the input signal may be connected.

In thin case, the input signal is decoded by using the decoder incorporated in the external receiver, whereby it can be determined whether the input signal is a MP3 stream signal 100 or a PCM signal 200. When the input signal is a MP3 stream signal 100, the input signal is decoded in the external receiver before it is converted from a digital to an analog signal. When the input signal is a PCM signal 200, the input signal is converted from a digital to an analog signal in the external receiver.

In this way, a signal processing process selected according to the type of the input signal is performed on the input signal, whereby the signal output from the digital audio Interface 60 can be appropriately reproduced.

It should be noted that each component of the reproduction apparatus 1 shown in FIG. 1 may be implemented by hardware (e.g., a circuit) or may be implemented by software (e.g., a program). Alternatively, each component of the reproduction apparatus 1 shown in FIG. 1 may be implemented by a combination of hardware and software.

FIG. 3 shows a structure of the input signal determination section 20. The input signal determination section 20 includes a data counter 21, a synchronization signal detection section 22, a synchronization signal counter storage section 23, a first synchronization signal address storage section 24, a type determination section 25, a header information analyzing section 26, and a next synchronization signal address storage section 27.

The data counter 21 counts the data amount of an input signal which la transmitted from the signal input section 10 (FIG. 1) to the input signal determination section 20. Then, the data counter 21 outputs an address of the input signal to the first synchronization signal address storage section 24 and the next synchronization signal address storage section 27.

The synchronization signal detection section 22 detects a synchronization signal in the input signal transmitted from the signal input section 10 to the input signal determination section 20. Then, the synchronization signal detection section 22 outputs a detection signal which indicates a result of the detection to the data counter 21, the synchronization signal counter storage section 23, and the header information analyzing section 26.

The synchronization signal counter storage section 23 receives the detection signal output from the synchronization signal detection section 22, and increments value C of the synchronization signal counter storage section 23 by “1” in response to the detection signal. Then, the synchronization signal counter storage section 23 outputs the incremented value to the type determination section 25.

The first synchronization signal address storage section 24 stores the address output from the data counter 21 in response to the detection signal resulting from the first synchronization signal. The first synchronization signal address storage section 24 outputs the stored address to the type determination section 25.

The type determination section 25 determines the type of the input signal based on whether or not the address stored in the first synchronization signal address storage section 24 exists within a predetermined search area of the input signal and whether or not the value of the synchronization signal counter storage section 23 is equal to or larger than N. The type determination section 25 determines whether the input signal which is input to the input signal determination section 20 is a MP3 stream signal 100 or a PCM signal 200, and outputs a result of the determination to the signal processing section 30.

In response to the detection signal output from the synchronization signal detection section 22, the header Information analyzing section 26 calculates the length of a variable-length frame which includes the detected synchronization signal and calculates, based on the calculated frame length, an address interval between the first synchronization signal and a next synchronization signal. The header information analyzing section 26 outputs this calculated address interval to the next synchronization signal address storage section 27,

The next synchronization signal address storage section 27 calculates an address of a synchronization signal which is next to the first synchronization signal (next synchronization signal address) based on the address stored In the first synchronization signal address storage section 24 and the address interval calculated by the header information analyzing section 26. When the next synchronization signal address matches an address output from the data counter 21 in response to a detection signal, the next synchronization signal address storage section 27 stores the address output from the data counter 2.

FIG. 4 is a flowchart for illustrating an operation of the input signal determination section 20 shown in FIG. 3. The input signal determination section 20 performs steps S401 through S415. A flow of the operation of the input signal determination section 20 is described with reference to FIG. 4 In conjunction with FIG. 3.

At step S401, the input signal determination section 20 initializes a leading address P₁ within a predetermined search area of an input signal and a first synchronization signal address P₂ stored in the first synchronization signal address storage section 24 (for example, P₁=0 and P₂=0). Such an initialization is performed, for example, at the startup of the reproduction apparatus 1.

At step S402, it is determined whether or not a first synchronization signal exists within the predetermined search area. For example, the determination is performed as described below.

Referring to FIG. 2A, in a MP3 stream signal 100, a synchronization signal 111 is 12-bit data. The synchronization signal 111 has a value “0×fff”. thus, the synchronization signal detection section 22 compares last 12-bit data Including currently-input data with the value “0×fff” which indicates the synchronization signal. When the synchronization signal detection section 22 detects the first synchronization signal, the synchronization signal detection section 22 outputs a detection signal which indicates a result of the detection of the synchronization signal to the data counter 21. In response to this detection signal, the data counter 21 outputs an address of the detected synchronization signal to the type determination section 25. The type determination section 25 determines whether or not the address of the detected synchronization signal exists within the predetermined search area. This predetermined search area may be selected according to the capacity of the reproduction apparatus 1. In embodiment 1, the predetermined search area is a 2 Kbyte area.

If “No” at step S402, the type determination section 25 determines that the input signal which has input to the reproduction apparatus 1 is a PCM signal (step S403), and the input signal determination section .20 ends the determination process.

If “Yes” at step S402, the determination process proceeds to step S404.

At step S404, the synchronization signal detection section 22 initializes count value C of the synchronization signal counter storage section 23 (e.g., C=0). Such an initialization is performed when the synchronization signal detection section 22 detects a first synchronization signal within the predetermined search area.

At step S405, the first synchronization signal address storage section 24 stores first synchronization signal address P₂ output from the data counter 21 in response to the detection signal resulting from the first synchronization signal.

At step S406, the header information analyzing section 26 analyzes a frame header included in the input signal in response to the detection signal output from the synchronization signal detection section 22.

At step S407, the header information analyzing section 26 determines based on a result of the analysis of the frame header whether or not the bit rate of the input signal is indeterminate. When the bit rate has a value “0×00” or “0×0f”, the bit rate is indeterminate.

If “Yes” at step S407, the determination process of the input signal determination section 20 proceeds to step S415.

If “No” at step S407, the determination process of the input signal determination section 20 proceeds to step S408.

At step S408, the header information analyzing section 26 calculates the length of a frame which includes the detected synchronization signal based on the bit rate and a sampling frequency included in the frame header. The length of a frame of a MP3 stream signal defined by MPEG1 Layer 3, F_{L}, is represented by expression 1:

F_{L}=(1152/FS)×(BR/8)[byte]

where FS denotes a sampling frequency, and BR denotes a bit rate. It should be noted that expression 1 represents the length F_{L} of a frame of a MP3 stream signal when the sampling frequency FS=48000 Hz.

At step S409, the next synchronization signal address storage section 27 calculates an address of a synchronization signal next to the first synchronization signal (next synchronization signal address) based on address P₂ stored in the first synchronization signal address storage section 24 and the frame length F_{L} (address interval) calculated by the header information analyzing section 26.

At step S410, the next synchronization signal address storage section 27 determines whether or not the next synchrontzation signal exists at the calculated next synchronization signal address. This determination is performed by determining whether or not the address which is output from the data counter 21 in response to the detection signal matches with the next synchronization signal address.

If “No” at step S410, the determination process of the input signal determination section 20 proceeds to step S415.

If “Yes” at step S410, the determination process of the input signal determination section 20 proceeds to step S411.

At step S411, the next synchronization signal address storage section 27 stores the next synchronization signal address calculated by the section 27.

At step S412, the synchronization signal counter storage section 23 increments count value C of the synchronization signal counter storage section 23 by “1” every time the next synchronization signal address is stored in the next synchronization signal address storage section 27. Then, the synchronization signal counter storage section 23 outputs the incremented value C to the type determination section 25.

At step S413, the type determination section 25 determines the type of the input signal based on whether or not the count value C of the synchronization signal counter storage section 23 is equal to or greater than a predetermined threshold value (N).

If “Yes” at step S413, the type determination section 25 determines that the input signal supplied to the reproduction apparatus 1 is a MP3 stream signal (step S414), and the input signal determination section 20 ends the determination process.

If “No” at step S413, the determination process of the input signal determination section 20 proceeds to step S406.

At step S415, the input signal determination section 20 modifies the predetermined search area. A leading address of the modified search area is greater than address P₂ stored in the first synchronization signal address storage section 24 by a certain number of bits.

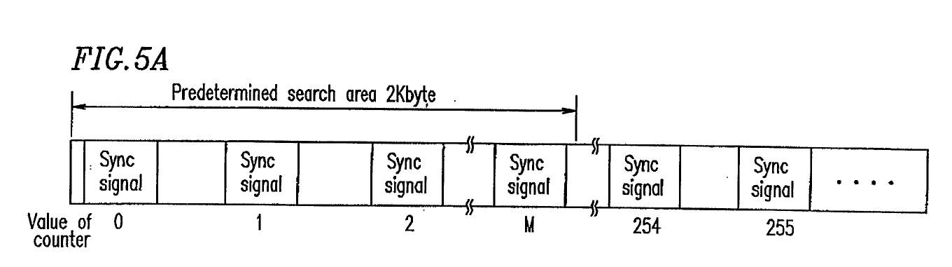

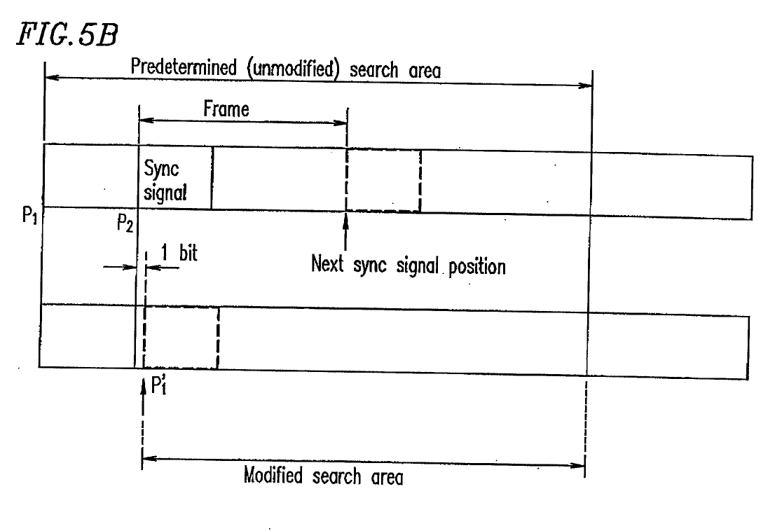

FIG. 5A shows an example of an input signal. In this example, the value C of the synchronization signal counter storage section 23 is equal to or greater than the predetermined threshold value N (N=255). Furthermore, a first synchronization signal exists within a predetermined search area of the input signal. Thus, the input signal determination section 20 determines that this input signal is a MP3 stream signal.

FIG. 5B shows a predetermined (unmodified) search area and a modified search area. In FIG. 5B, P₁ denotes a leading address of the predetermined (unmodified) search area; P₂ denotes a first synchronization signal address; and P₁′ denotes a leading address of the modified search area,

In FIG. 5B, leading address P₁′ within the modified search area is greater than address P₂ stored in the first synchronization signal address storage section 24 by one bit.

In embodiment 1, the predetermined search area is 2 Kbyte, and the threshold value N is 255. Even when the input signal includes a signal which has the same value as that of the synchronization signal but is different from the synchronization signal, the type of the input signal can be accurately determined by previously providing a large search area and setting threshold value N to a large value.

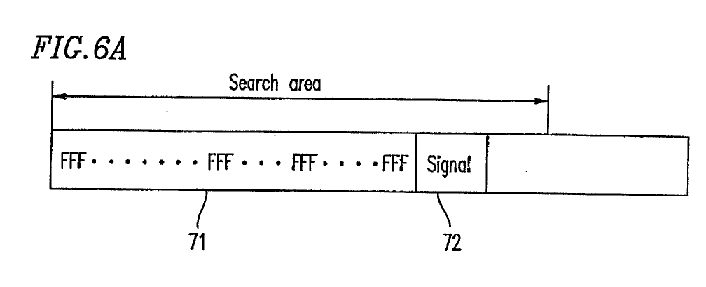

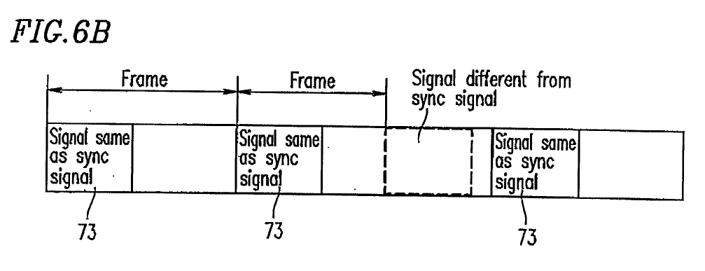

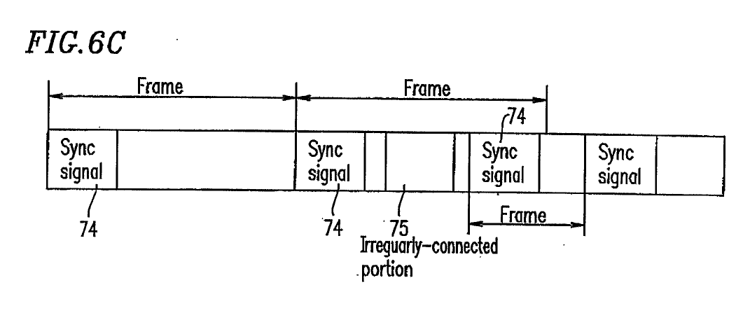

FIGS. 6A through 6C show specific examples of an input signal whose signal type is likely to be erroneously determined by a conventional reproduction apparatus. However, a reproduction apparatus 1 of the present invention can correctly determine the type of such signals shown In FIGS. 6A through 6C.

FIG. 6A shows an input signal where data contained before a signal 72 is only a series of “F”s (signal portion 71). In a MP3 stream signal 100 (FIG. 2A), a synchronization signal 111 has a value “0×fff”. Thus, when the signal of FIG. 6A is input to a conventional reproduction apparatus, the conventional reproduction apparatus cannot correctly determine whether the signal 72 is a synchronization signal or “trash data (data irrelevant to data in a track to be reproduced)”. However, when the signal of FIG. 6A is input to the reproduction apparatus 1 of the present invention, it is determined, from a result of an analysis of a frame header subsequent to the synchronization signal, that the bit rate of this input signal is indeterminate. As a result, the reproduction apparatus 1 can determine that the signal 72 is not a synchronization signal.

FIG. 6B shows a specific example of a PCM digital sound signal which includes signals (dummy signals) identical to a synchronization signal included in a MP3 stream signal. When the PCM digital sound signal of FIG. 6B is input to the reproduction apparatus 1 of the present invention, there is very little chance of the dummy signals appearing in the input signal at an Interval equal to an address interval defined by a bit rate included in a frame header of a MP3 signal. As a result, there is little chance that value C of the synchronization signal counter storage section 23 reaches a predetermined threshold value N. Thus, the reproduction apparatus 1 of the present invention can correctly determine that the input signal is a PCM digital sound signal.

FIG. 6C shows a specific example of a MP3 stream signal with an irregular frame arrangement where a frame is connected to an intermediate portion of a previous frame. When the MP3 stream signal of FIG. 6C is input to the reproduction apparatus 1 of the present invention, If an irregularly-connected portion 75 is within a predetermined synchronization signal search area, detection of a synchronization signal is performed again from a position immediately after the irregularly-connected portion 75. As a result, the reproduction apparatus 1 of the present invention can correctly determine that the input signal is a MP3 stream signal.

Thus, as described above, according to a reproduction apparatus or reproduction method of the present invention, whether a signal input to the reproduction apparatus is a PCM signal or a digital sound signal encoded at a variable rate can be determined.

It Is not an indispensable requirement that the input signal determination section 20 modifies a predetermined search area of an input signal based on a value of a bit rate which is obtained from a result of an analysis of a frame header. The input signal determination section 20 may modify the predetermined search area based on the bit rate designated in a frame header and at least one of the “frame state data values” other than the value of the bit rate designated in the frame header, so as to determine whether or not a synchronization signal exists within the modified search area.

Referring to FIG. 2A again, the “frame state data values” means values of data included in a frame header 112. Specifically, the “frame state data values” are values of data which indicates the state of a frame 110 including the frame header 112 (e.g., a bit rate 115, a layer 116, a sampling frequency 117, an emphasis 118, etc.).

The frame header 112 of a MP3 stream signal includes a plurality of frame state data. These data included in the frame header 112 can be used to determine that the input signal is a MP3 stream signal. By additionally providing an operation for determining based on these data whether or not an input signal is a MP3 stream signal, the probability of correctly determining that the frame 110 is a frame of a MP3 stream signal is increased. As a result, determination of whether or not an input signal is a MP3 signal can be achieved by only examining a small number of frames. Thus, the type of an input signal can be correctly determined during a short period of time.

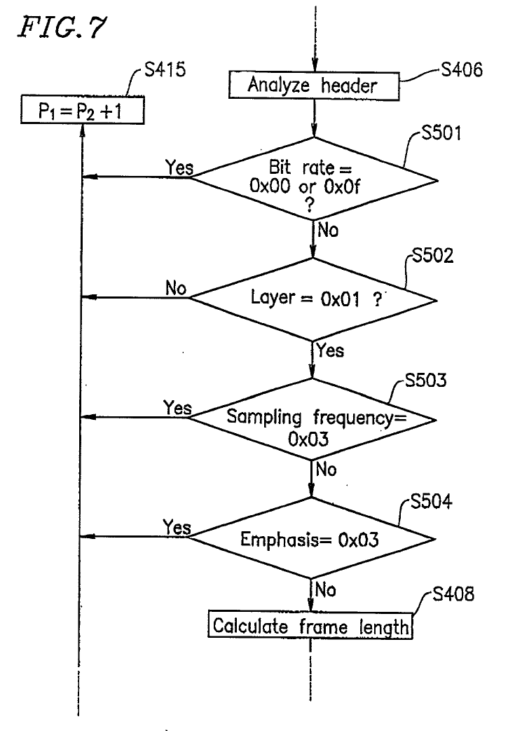

FIG. 7 is a flowchart of an analyzing process of a frame header performed by the input signal determination section 20. In FIG. 7, like elements are indicated by like reference numerals used in FIG. 4, and detailed descriptions thereof are omitted.

At step S501, the header information analyzing section 26 analyzes a frame header to determine whether or not the bit rate has a value which indicates that the bit rate is indeterminate. In this example, if the bit rate has a value “0×00” or “0×0f”, the bit rate is indeterminate.

If “Yes” at step S501, the analyzing process of the input signal determination section 20 proceeds to step S415 (see FIG. 4).

If “No” at step S501, the analyzing process of the input signal determination section 20 proceeds to step S502.

At step S502, the header information analyzing section 26 analyzes a frame header to determine whether or not the value of the layer indicates that a frame including the analyzed frame header is a frame of a MP3 stream signal. In this example, if the layer does not have a value “0×01”, a frame including the analyzed frame header is not a frame of a MP3 stream signal.

If “No” at step S502, the analyzing process of the input signal determination section 20 proceeds to step S415.

If “Yes” at step S502, the analyzing process of the input signal determination section 20 proceeds to step S503.

At step S503, the header information analyzing section 26 analyzes a frame header to determine whether or not the value of the sampling frequency indicates that a frame including the analyzed frame header is a frame of a MP3 stream signal. In this example, if the sampling frequency has a value “0×03”, a frame including the analyzed frame header is not a frame of a MP3 stream signal

If “Yes” at step S503, the analyzing process of the input signal determination section 20 proceeds to step S415.

If “No” at step S503, the analyzing process of the input signal determination section 20 proceeds to step S504.

At step S504, the header information analyzing section 26 analyzes a frame header to determine whether or not the value of the emphasis indicates that a frame including the analyzed frame header is a frame of a MP3 stream signal. In this example, if the sampling frequency has a value “0×03”, a frame including the analyzed frame header is not a frame of a MP3 stream signal.

If “Yes” at step S504, the analyzing process of the input signal determination section 20 proceeds to step S415.

If “No” at step S504, the analyzing process of the input signal determination section 20 proceeds to step S408.

As described above, according to a reproduction apparatus of the present invention, an operation for determining based on data included in a frame header whether or not an input signal is a MP3 stream signal can be added. The probability of correctly determining the type of an input signal is increased by only examining a small number of frames. As a result, determination of whether or not an input signal is a MP3 signal can be achieved by only examining a small number of frames. Thus, the type of an input signal can be correctly determined during a short period of time.

Embodiment 2

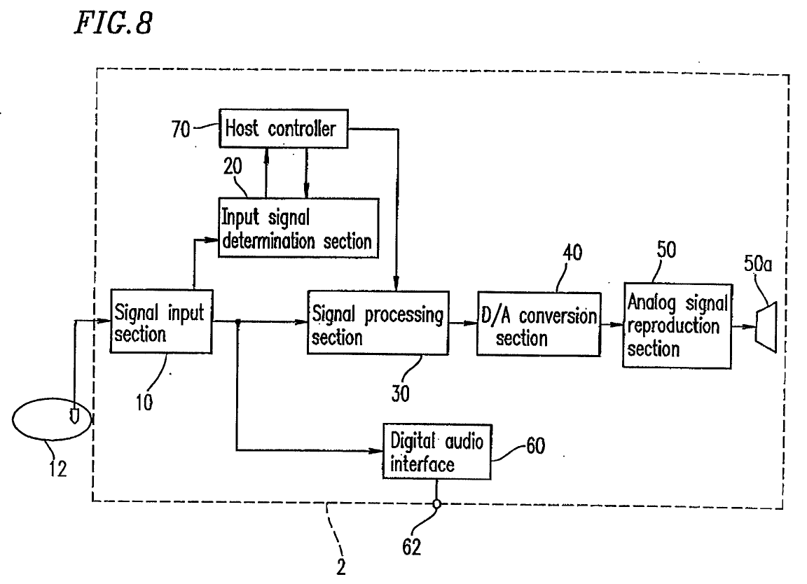

FIG. 8 shows a structure of a reproduction apparatus 2 according to embodiment 2 of the present invention. The reproduction apparatus 2 includes a host controller 70 in addition to the components of the reproduction apparatus 1 (FIG. 1).

In FIG. 8, like elements are indicated by like reference numerals used in FIG. 1, and detailed descriptions thereof are omitted.

The host controller 70 changes operating conditions of the input signal determination section 20. The input signal determination section 20 outputs a detection signal to the host controller 70 instead of the signal processing section 30. The host controller 70 supplies a control signal to the signal processing section 30. The host controller 70 outputs to the input signal determination section 20 an operating condition setting signal for initializing the operating conditions of the input signal determination section 20.

For examples the operating conditions of the input signal determination section 20 includes a minimum unit of an input signal, a predetermined search area, a modified search area, threshold value N, a value of frame state data included in a frame header, etc.

The operating conditions of the input signal determination section 20 can be appropriately set according to the performance of the reproduction apparatus 2. For example, the minimum unit of an input signal is 1 bit. The predetermined search area only needs to have a length equal to or longer than one frame of a MP3 stream signal. Furthermore, a leading address of the modified search area only needs to be at a position at least one bit later from the last address of a first synchronization signal.

The host controller 70 prioritizes the frame state data values in a frame header and selects, based on the priority, one of the frame state data values which will be analyzed by the header information analyzing section 26.

The host controller 70 outputs to the input signal determination section 20 an operating condition setting signal for initializing the operating conditions of the input signal determination section 20 before the section 20 starts to operate. For example, initialization of the operating conditions of the input signal determination section 20 is performed at the startup of the reproduction apparatus 2.

According to embodiment 2 of the present invention, when a signal shown in FIG. 6A is input to the reproduction apparatus 2, a predetermined search area is set by the host controller 70 so as to be broader than that of the reproduction apparatus 1. With a broader search area, the reproduction apparatus 2 can correctly determine the type of a signal whose type cannot be correctly determined by the reproduction apparatus 1. Furthermore, in the reproduction apparatus 2, when threshold value N of the synchronization signal counter storage section 23 is set by the host controller 70 to a value greater than that set in the reproduction apparatus 1, the reproduction apparatus 2 can more correctly determine the type of an input signal than the reproduction apparatus 1.

When threshold value N is set to a small value, or when the input rate of an input signal is set to a high rate, a time required for determining that the input signal is a MP3 stream signal can be shortened. In this case, a period from a time when the MP3 stream signal is input to the reproduction apparatus to a time when the MP3 stream signal is decoded can be shortened.

According to embodiment 2 of the present invention, the error resistance of the reproduction apparatus 2 can be changed by changing with the host Controller 70 the frame state data used in the header information analyzing section 26. Furthermore, during a period when the input signal determination section 20 determines the type of an input signal using the frame state data, the input signal determination section 20 informs the host controller 70 about the status of the determination operation, and weighting or priority for the frame state data which is used for determining the type of an input signal can be appropriately changed from outside of the reproduction apparatus 2 by using the host controller 70 based on the status of a signal input operation. Thus, the type of an input signal can be correctly determined.

As described above, according to a reproduction apparatus of embodiment 2, the operating condition of the input signal determination section 20 can be appropriately changed. Thus, a reproduction apparatus with improved performance demanded by users can be achieved.

The reproduction process described in each of embodiments 1 and 2 can be performed by a program which directs a computer to perform the reproduction process. Furthermore, the reproduction process described in each of embodiments 1 and 2 can be recorded on a recording medium in the form of a program which directs a computer to perform the reproduction process. The recording medium may be any type of computer-readable recording medium, such as a floppy disk, a CD-ROM, etc. A reproduction processing program read from a recording medium is installed in a computer, thereby allowing the computer to function as a reproduction apparatus.

According to the present invention, a synchronization signal is detected in an input signal, and the type of the input signal is determined based on whether or not the detected synchronization signal is the first synchronization signal among a series of synchronization signals within a predetermined search area. With such an arrangement, the type of the input signal can be determined by only decoding a portion of the input signal, and the input signal can be subjected to a signal processing process selected according to the type of the input signal. As a result, emission of noise by a reproduction apparatus can be prevented.

According to the present invention, an operation for determining based on data included in a frame header whether or not an input signal is a MP3 stream signal can be added. Thus, the type of an input signal can be determined with high accuracy by only examining a small number of frames. As a result, the type of an input signal can be correctly determined during a short period of time.

According to the present invention, the operating conditions of an input signal determination section can be appropriately changed. Thus,are production apparatus with improved performance demanded by users can be achieved.

Various other modifications will be apparent to and can be readily made by those skilled in the art without departing from the scope and spirit of this invention. Accordingly, it is not intended that the scope of the claims appended hereto be limited to the description as set forth herein, but rather that the claims be broadly construed.

What is claimed is:

1. A reproduction apparatus, comprising:
a signal input section for receiving an input signal
an input signal determination section for determining a type of the input signal based on whether or not a first synchronization signal among a series of N synchronization signal exists within a predetermined search area of the input signal (N is an integer equal to or greater than 2); and
a signal processing section for performing a signal processing process selected according to the type of the input signal on the input signal,

2. A reproduction apparatus according to claim 1, wherein:
the input signal includes a variable-length frame including a header portion and a data portion; and
the input signal determination section determines whether or not a synchronization signal exists within the predetermined search area and, when a synchronization signal exists within the predetermined search area, calculates a position of a next synchronization signal based on the length of the frame so as to determine whether a next synchronization signal exists at the calculated position of the next synchronization signal.

3. A reproduction apparatus according to claim 2, wherein the length of the frame is calculated based on a bit rate of the header portion and a sampling frequency of the header portion.

4. A reproduction apparatus according to claim 2, wherein the input signal determination section modifies the predetermined search area if a next synchronization signal does not exist at the calculated position of the next synchronization signal so as to determine whether or not a synchronization signal exists within the modified predetermined search area.

5. A reproduction apparatus according to claim 1, wherein:
the input signal includes a variable-length frame including a header portion and a data portion; and
the input signal determination section determines whether or not a bit rate of the header portion has a value which indicates that the bit rate is indefinite and, when the bit rate of the header portion has a value which indicates that the bit rate is indefinite, modifies the predetermined search area so as to determine whether a synchronization signal exists within the modified predetermined search area.

6. A reproduction apparatus according to claim 1, wherein:
the input signal includes a variable-length frame including a header portion and a data portion; and
the input signal determination section modifies the predetermined search area based on a value of a bit rate of the header section and at least one of data which indicates a state of the frame of the header portion except for the value of the bit rate of the header section so as to determine whether or not a synchronization signal exists within the modified predetermined search area.

7. A reproduction apparatus according to claim 1, wherein the predetermined search area is 2 Kbyte.

8. A reproduction apparatus according to claim 1 wherein, when the first synchronization signal among the series of N synchronization signal exists within the predetermined search area, the input signal determination section determines that the input signal is an encoded digital sound signal.

9. A reproduction apparatus according to claim 1 wherein, when the first synchronization signal among the series of N synchronization signal does not exist within the predetermined search area, the input signal determination section determines that the input signal is a pulse code modulation (PCM) digital sound signal.

10. A reproduction apparatus according to claim 1, wherein the input signal determination section includes:
a data counter for counting a date amount of the input signal to output an address of the input signal;
ea synchronization signal detection section for detecting a synchronization signal in the input signal to output a detection signal which indicates a result of the detection;
a synchronization signal counter storage section in which the detection signal is incremented based on the detection signal output from the synchronization signal detection section;
a first synchronization signal address storage section for storing the address output from the data counter in response to a detection signal resulting from a first synchronization signal; and
a type determination section for determining the type of the input signal based on whether or not the address stored in the first synchronization signal address storage section exists within the predetermined search area and based on whether or not the value of the synchronization signal counter storage section Is equal to or greater than N.

11. A reproduction apparatus according to claim 10, wherein:
the input signal includes a variable-length frame including a synchronization signal, a header portion, and a data portion; and
the input signal determination section further includes
a header information analyzing section for calculating a length of the variable-length frame including the detected synchronization signal in response to the detection signal no as to calculate an address interval between the detected synchronization signal and a next synchronization signal, and
a next synchronization signal address storage section which calculates an address of a next synchronization signal next to the first synchronization signal based on the address stored In the first synchronization signal address storage section and the calculated address:interval and, when the calculated address of the next synchronization signal matches the address output from the data counter, stores the address output from the data counter.

12. A reproduction apparatus according to claim 1, further comprising a host controller for changing an operating condition of the input signal determination section.

13. A reproduction apparatus according to claim 12, wherein the operating condition of the input signal determination section Includes at least one of a minimum unit of the input signal, the predetermined search area, and the value N.

14. A reproduction apparatus according to claim 13, wherein the minimum unit of the input signal is 1 bit.

15. A reproduction apparatus according to claim 13, wherein:
the input signal includes a variable-length frame including a header portion and a data portion; and
the predetermined search area is greater than the length of the frame.

16. A reproduction apparatus according to claim 4, further comprising a host controller for changing an operating condition of the input signal determination section,
wherein the operating condition of the input signal determination section includes the modified predetermined search area.

17. A reproduction apparatus according to claim 16, wherein a leading address of the modified search area is at a position at least one bit greater than a last address of the first synchronization signal among the series of N synchronization signals.

18. A reproduction apparatus according to claim 6, further comprising a host controller for changing an operating condition of the input signal determination section,
wherein the operating condition of the input signal determination section is a value of at least one of data which Indicates a state of the frame included in the header portion.

19. A reproduction apparatus according to claim 18, wherein the host controller prioritizes the value of the at least one of the data which indicates the state of the frame included in the header portion and changes the value of the at least one of the data which indicates the state of the frame included in the header portion based on the priority of the value.

20. A reproduction method, comprising steps of:
receiving an input signal;
determining a type of the input signal based on whether or not a first synchronization signal among a series of N synchronization signal exists within a predetermined search area of-the input signal (N is an integer equal to or greater than 2); and
performing a signal processing selected according to the type of the input signal on the input signal.

21. A program for directing a computer to perform a reproduction process, the reproduction process comprising steps of:
receiving an input signal;
determining a type of the input signal based on whether or not a first synchronization signal among a series of N synchronization signal exists within a predetermined search area of the input signal (N is an integer equal to or greater than 2); and
performing a signal processing selected according to the type of the input signal on the input signal.

22. A computer-readable recording medium containing a program for directing a computer to perform a reproduction process, the reproduction process comprising steps of:
receiving an input signal;
determining a type of the input signal based on whether or not a first synchronization signal among a series of N synchronization signal exists within a predetermined search area of the input signal (N is an integer equal to or greater than 2): and
performing a signal processing process selected according to the type of the input signal on the input signal.
